(19) United States
(12) Patent Application Publication
(10) Pub. No.: US 2013/0248156 A1
(43) Pub. Date: Sep. 26, 2013

(54) MOLDING METHOD OF A HEAT DISSIPATING COVER FOR SPHERICAL LIGHT SOURCE

(71) Applicant: Chao-Chuan Chen, Taichung City (TW)

(72) Inventor: Chao-Chuan Chen, Taichung City (TW)

(21) Appl. No.: 13/429,460

(22) Filed: Mar. 26, 2012

(51) Int. Cl. F28F 13/18; B05D 3/12

(52) U.S. Cl. 165/133; 427/290

(57) ABSTRACT

A molding method of a heat dissipating cover for spherical light source includes cutting process, impact molding process, chamfering process, and coating process. A thermal conducting sheet is transformed into a semi-finished product by the impact molding process, and then the semi-finished product is curved and smoothed by the chamfering process in order to form a desired flowerpot or cup shape. In this way, the manufacturer can save time and money to produce an effective heat sink.

### BACKGROUND OF ME INVENTION

1. Field of the Invention

The present invention relates to a molding method of a heat dissipating cover, more particularly to a molding method of a heat dissipating cover for spherical light source.

2. Description of Related Art

With the development of high efficiency and high power LEDs, it has become possible to use LEDs in lighting and illumination. Replacement light bulbs have been made, as well as dedicated fixtures and LED lamps. LEDs are used as street lights and in other architectural lighting where color changing is used. However, light emitting efficiency of the LED lamp is easily affected by heat, particularly under high power of the electric current for a long time, the color performance becomes unstable. In addition, most of the electrical elements are damaged easily in the high temperature environment. How to design an efficient heat sink for the LED lamp becomes an important issue in this field.

The conventional heat dissipating devices are using several thermal conducting fins which are disposed around a light source, like light bulbs or LED module. The thermal conducting fins are often radially aligned, such that the heat can be conducted to the thermal conducting fins and dissipated into the air. The thermal conducting fins provide a lot of contacting area for the flowing air, and each of thermal conducting fins is made from materials with high thermal conductivity, such as copper, aluminum, and aluminum-alloys. Thus, the heat is dissipated into the air quickly via the thermal conducting fins. The thermal conducting fins can be further bent for increasing contacting area with the air.

Unfortunately, the cost of the copper, aluminum, and aluminum-alloys becomes so expensive day after day that the thermal conducting fins become more expensive to be manufactured. In addition, the row materials are often molded by the injection molding process, in which the products of the thermal conducting fins are unitary; thus it is not suitable to the various lamps or illuminants. Finally, to produce one bending thermal conducting fin with rigid structure is not easy on the assembly line.

The present invention has arisen to mitigate and/or obviate the disadvantages of the conventional.

### SUMMARY OF THE INVENTION

The main objective of the present invention is to provide an improved molding method of a heat dissipating cover for spherical light source.

To achieve the objective, a molding method of a heat dissipating cover for spherical light source comprises

Cutting process: a cutting sheet is cut from a thermal conducting sheet;

Impact molding process: the cutting sheet is placed on an impact molding machine; the impact molding machine comprises a top-molding part and a bottom-molding part; a semi-finished product is made by the top-molding part pressing the cutting sheet into the bottom-molding part; the semi-finished product is formed as a flowerpot or a cup;

Chamfering process: the semi-finished product is fastened in a chamfering machine at first, thereafter the semi-finished product is chamfered by rolling rollers of the chamfering machine;

Coating: take out the semi-finished product after the chamfering process, and then clean the inner and outer surfaces of the semi-finished product; thereafter heat dissipating coatings are uniformly coated on the inner and outer surfaces of the semi-finished product; after the heat dissipating coatings are drying, a heat dissipating cover is finished.

The material of the thermal conducting sheet is aluminum-alloys in the cutting process.

The shape of the top-molding part and the bottom-molding part are changeable rather than unitary.

The impact molding process and the chamfering process could be circling until the semi-finished product would be formed as desired as possible before entering into the coating process.

The heat dissipating coating is made from resins with high thermal conductivity in the coating process.

Further benefits and advantages of the present invention will become apparent after a careful reading of the detailed description with appropriate reference to the accompanying drawings.

### BRIEF DESCRIPTION OF THE DRAWINGS

FIG. 1 is a flowchart of a molding method of a heat dissipating cover for spherical light source in accordance with the present invention;

FIG. 2 is a perspective view for showing a cutting process;

FIG. 3 is a side view for showing an initial stage of a first impact molding process;

FIG. 4 is a side view for showing a final stage of the first impact molding process;

FIG. 5 is a side view for showing an initial stage of a second impact molding process;

FIG. 6 is a side view for showing a final stage of the second impact molding process;

FIG. 7 is a side view for showing a semi-finished product to be fastened in a chamfering machine;

FIG. 8 is a side view for showing the semi-finished product to be chamfered by rollers;

FIG. 9 is a side view of the semi-finished product after the chamfering process;

FIG. 10 is a side view of the heat dissipating cover after the coating process;

FIG. 11 is a perspective view of the heat dissipating cover after the coating process; and

FIG. 12 is a perspective view for showing a spherical light source assembled to the heat dissipating cover.

### DETAILED DESCRIPTION OF THE INVENTION

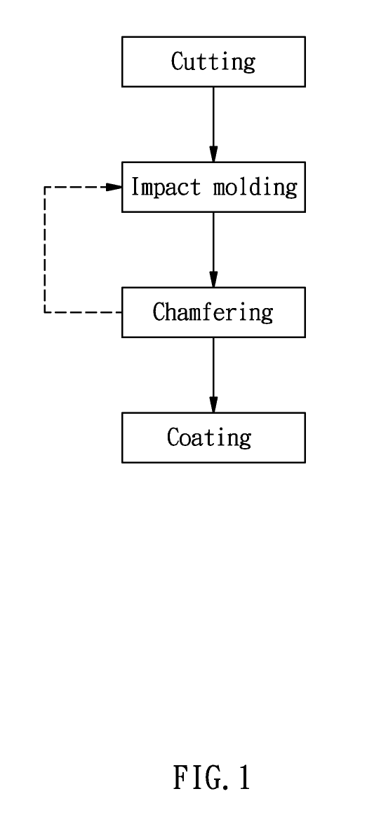

Referring to FIG. 1, a molding method of a heat dissipating cover for spherical light source in accordance with the present invention comprises the following processes:

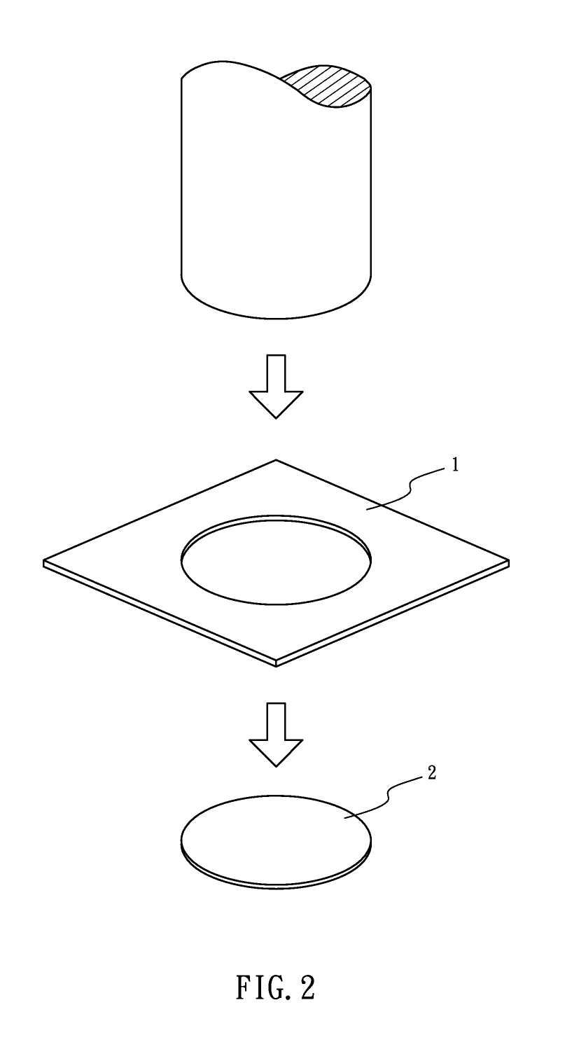

Cutting process: a cutting sheet 2 is cut from a thermal conducting sheet 1 as shown in FIG. 2 (In FIG. 2, the cutting sheet 2 is a circular sheet, but the circular shape is not necessary in the present invention);

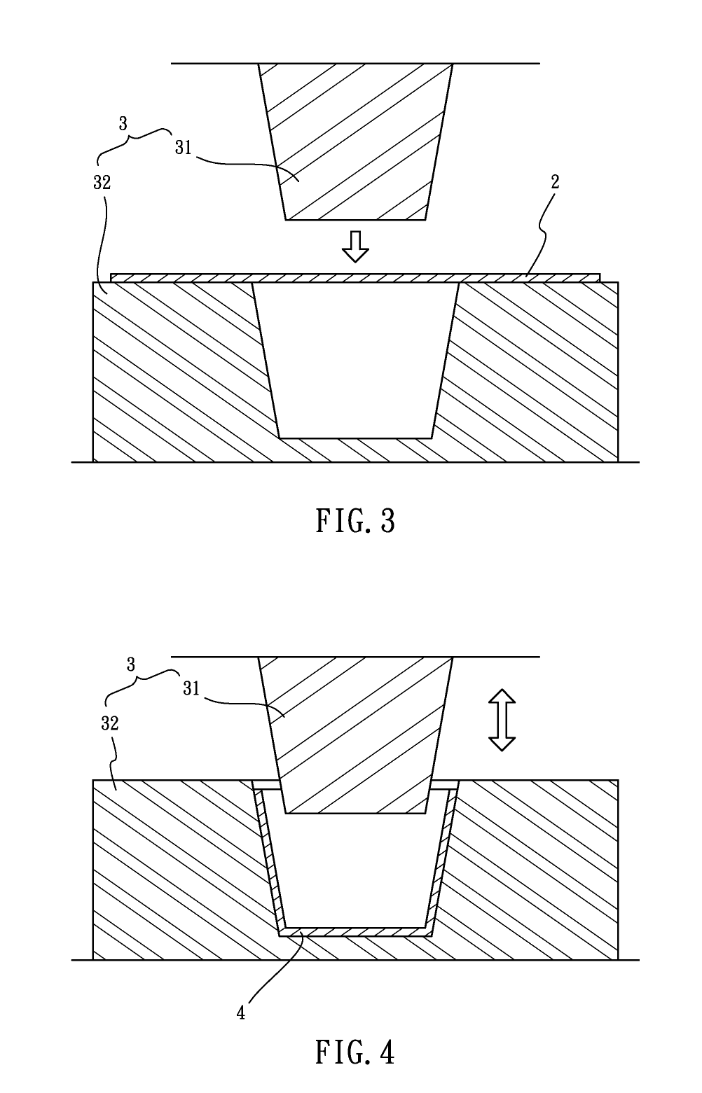

Impact molding process: the cutting sheet 2 is placed on an impact molding machine 3. The impact molding machine 3 comprises a top-molding part 31 and a bottom-molding part 32. Referring to FIGS. 3-6, a semi-finished product 4 is made by the top-molding part 31 pressing the cutting sheet 2 into the bottom-molding part 32, wherein the top-molding part 31 should not completely move into the bottom-molding part 32, otherwise the cutting sheet 2 might be broken or the semi-finished product 4 might become too flat. The semi-finished product 4 is formed as a flowerpot or a cup;

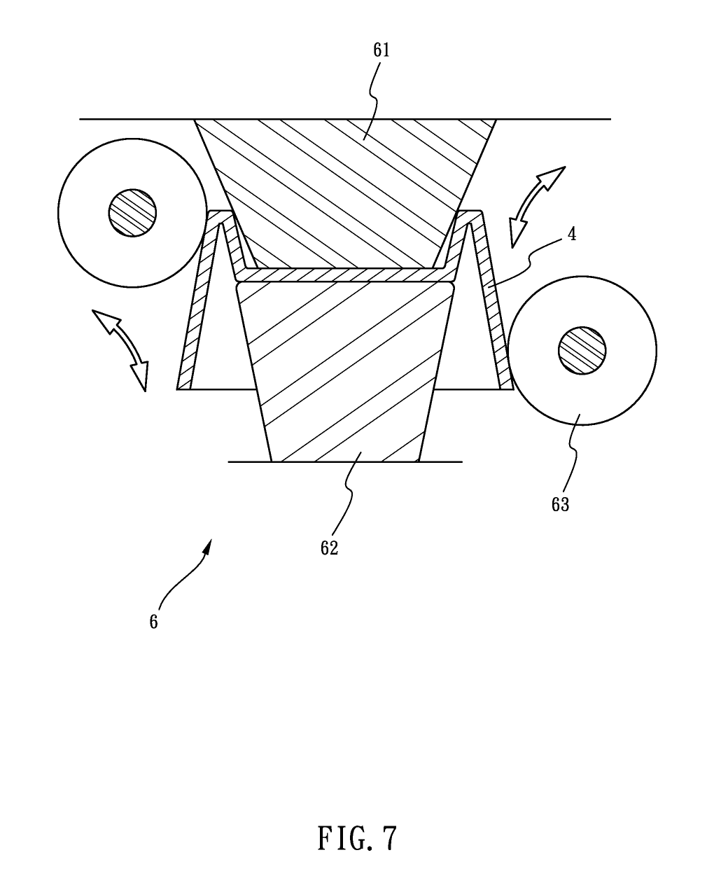

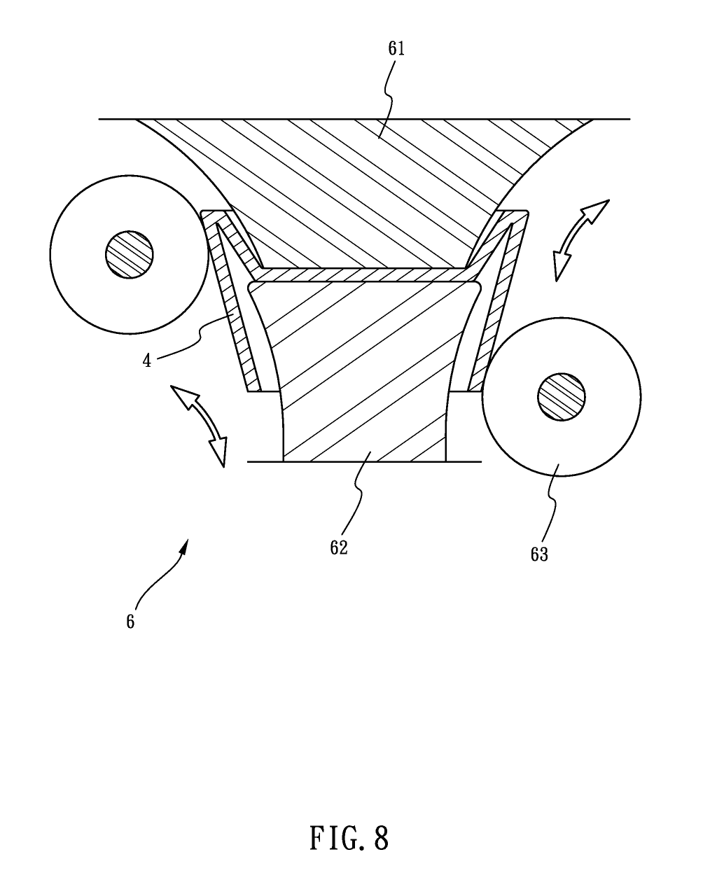

Chamfering process: the semi-finished product 4 is fastened on a bottom block 62 at first, thereafter the semi-finished product 4 is chamfered by rolling rollers 63 of a chamfering machine 6 as shown in FIGS. 7-8;

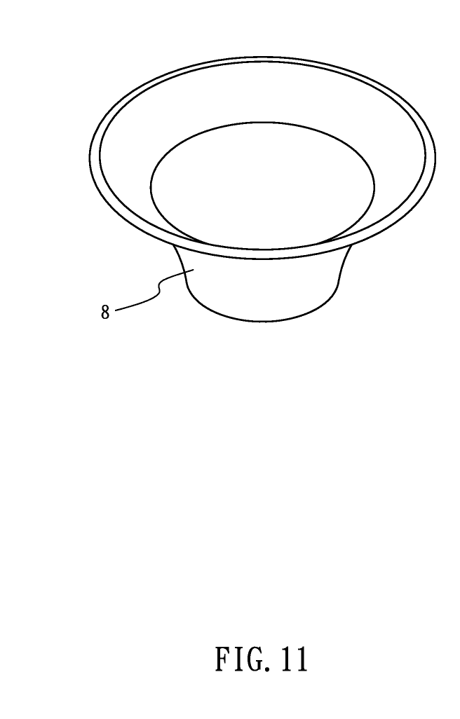

Coating: take out the semi-finished product 4 after the chamfering process, and then clean the inner and outer surfaces of the semi-finished product 4. Thereafter, heat dissipating coatings 7 are uniformly coated on the inner and outer surfaces of the semi-finished product 4. After the heat dissipating coatings 7 are drying, a heat dissipating cover 8 is finished as shown in FIGS. 10-11.

The conventional thermal conducting fins are replaced by the heat dissipating cover 8 which is made by the above process, and the heat dissipating cover 8 can help light source to dissipate heat into the air quickly.

In the cutting process, the material of the thermal conducting sheet 1 is aluminum-alloys.

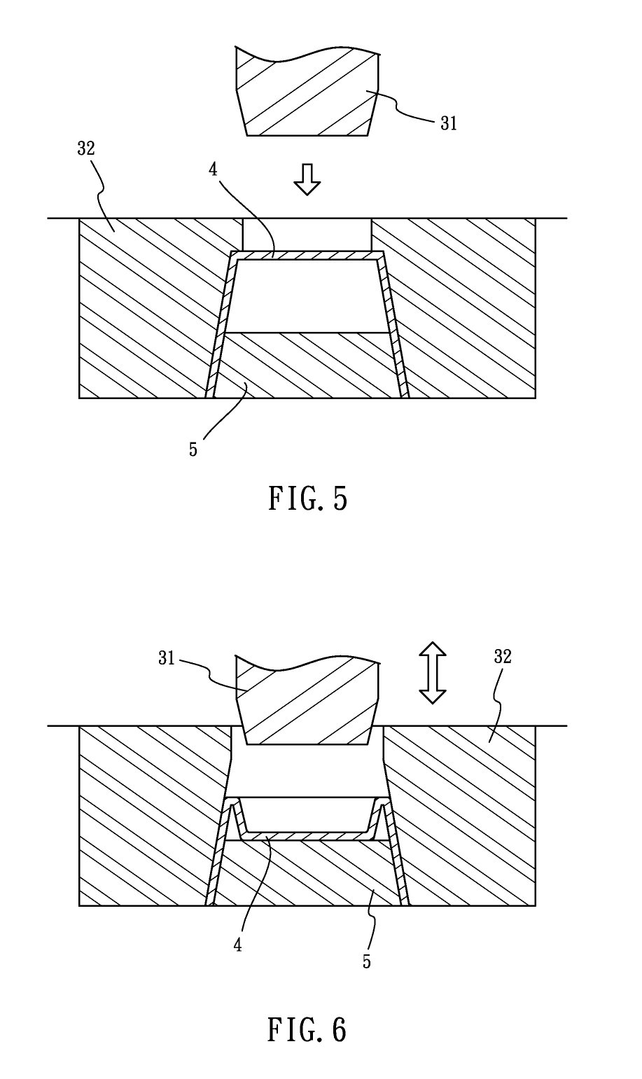

In the impact molding process, the impact molding process comprises a first impact molding process and a second impact molding process. The first impact molding process is that the top-molding part 31 presses the cutting sheet 2 downwardly into the bottom-molding part 32 as shown in FIGS. 3-4. After the first impact molding process, the semi-finished product 4 is bent downwardly to form a flowerpot or a cup. The semi-finished product 4 is taking out and an opening of the semi-finished product 4 is placed downward for entering the second impact molding process. In the second impact molding process, the opening of the semi-finished product 4 is supported by a molding block 5, and the semi-finished product 4 is placing in another bottom-molding part 32 which has different shape from the bottom-molding part 32 of the first impact molding process as shown in FIG. 5. Thereafter, another top-molding part 31 which has different shape from the top-molding part 31 of the first impact molding process presses the top side of the semi-finished product 4 downwardly to the molding block 5 with a constant depth to form the semi-finished product 4 as shown in FIG. 6. Therefore, the semi-finished product 4 has two depressions on the top and bottom sides.

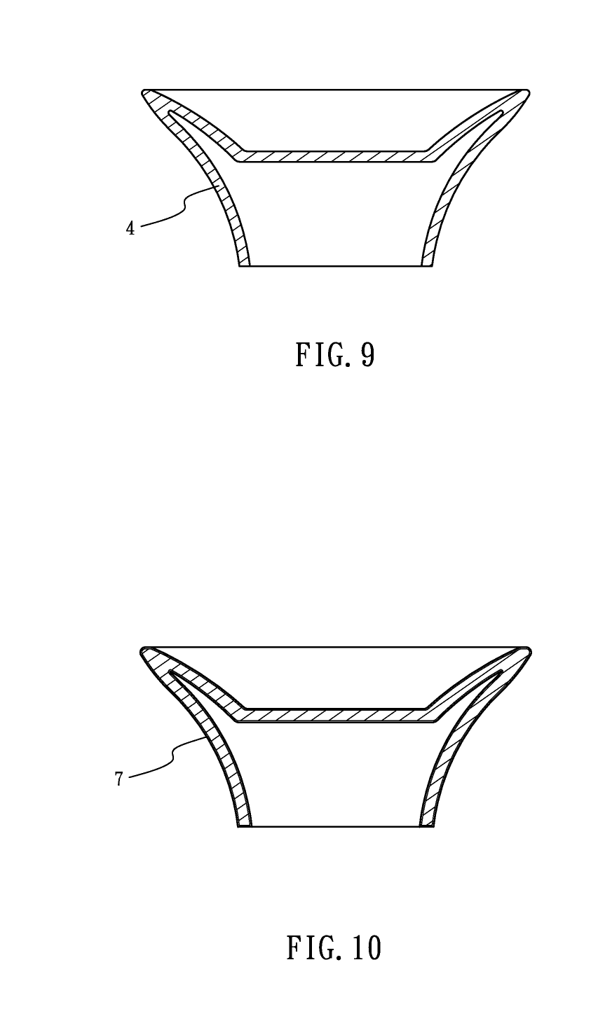

In the chamfering process, a top block 61 and the bottom block 62 clamp the semi-finished product 4 tightly in the impact molding machine 6 as shown in FIG. 7. The rollers 63 of the chamfering machine 6 are rolling on the peripheral of the semi-finished product 4 from up to down, so that the semi-finished product 4 is necking as shown in FIG. 8. The rolling rollers 63 further makes the peripheral of the semi-finished product 4 be curving. The total area of the curving semi-finished product 4 is larger than the original semi-finished product 4 in order to increase the contacting area with the air as shown in FIG. 9.

In the coating process, the heat dissipating coating 7 is not only to dissipate heat, but also to smooth the surface of the semi-finished product 4 as show in FIGS. 10-11. The heat dissipating coating 7 is made from boron nitride, BN-cermets, nano-materials with high thermal conductivity, or resins with high thermal conductivity.

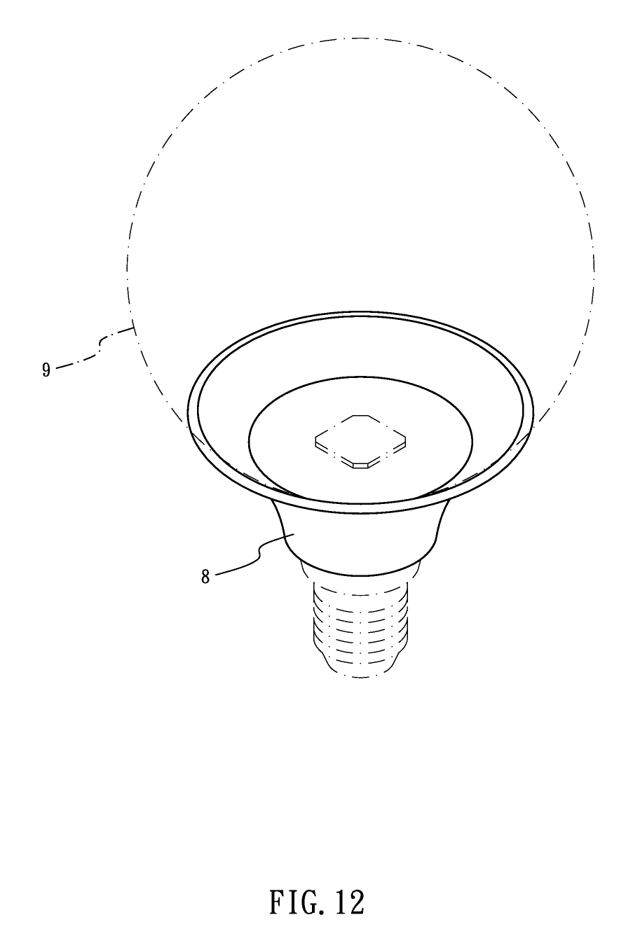

Referring to FIG. 12, the heat dissipating cover 8 can make the spherical light source 9 to dissipate heat into the air quickly.

Besides, the impact molding process and the chamfering process could be circling until the semi-finished product 4 would be formed as desired as possible before entering into the coating process.

Although the invention has been explained in relation to its preferred embodiment, it is to be understood that many other possible modifications and variations can be made without departing from the spirit and scope of the invention as hereinafter claimed.

What is claimed is:

1. A molding method of a heat dissipating cover for spherical light source comprising:
Cutting process: a cutting sheet is cut from a thermal conducting sheet;
Impact molding process: the cutting sheet is placed on an impact molding machine; the impact molding machine comprises a top-molding part and a bottom-molding part; a semi-finished product is made by the top-molding part pressing the cutting sheet into the bottom-molding part; the semi-finished product is formed as a flowerpot or a cup;
Chamfering process: the semi-finished product is fastened in a chamfering machine at first, thereafter the semi-finished product is chamfered by rolling rollers of the chamfering machine;
Coating: take out the semi-finished product after the chamfering process, and then clean the inner and outer surfaces of the semi-finished product; thereafter heat dissipating coatings are uniformly coated on the inner and outer surfaces of the semi-finished product; after the heat dissipating coatings are drying, a heat dissipating cover is finished.

2. The molding method of a heat dissipating cover for spherical light source as claimed in claim 1, wherein the material of the thermal conducting sheet is aluminum-alloys in the cutting process.

3. The molding method of a heat dissipating cover for spherical light source as claimed in claim 1, wherein the shape of the top-molding part and the bottom-molding part are changeable rather than unitary.

4. The molding method of a heat dissipating cover for spherical light source as claimed in claim 1, wherein the impact molding process and the chamfering process could be circling until the semi-finished product would be formed as desired as possible before entering into the coating process.

5. The heat dissipating device for lamps as claimed in claim 1, wherein the heat dissipating coating is made from resins with high thermal conductivity in the coating process.
